(19) United States
(12) Patent Application Publication
(10) Pub. No.: US 2008/0263622 A1
(43) Pub. Date: Oct. 23, 2008

(54) Digital Broadcasting Receiving Apparatus and Method of Receiving Thererof

(76) Inventor: Jong Woon Kim, Gwangiu (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/910,136

(22) PCT Filed: Feb. 16, 2007
(86) PCT No.: PCT/KR07/00869

§ 371 Date: Sep. 28, 2007

(30) Foreign Application Priority Data
Feb. 20, 2006 (KR) 10-2006-0016157

(51) Int. Cl. H04N 7/16

(52) U.S. Cl. 725/151

(57) ABSTRACT

Provided is a digital broadcasting receiving apparatus and method. The digital broadcasting receiving apparatus includes an out-of-band signal receiving unit for receiving an out-of-band signal through a cable, a out-of-band signal transmission unit for transmitting the out-of-band signal through the cable, and a control unit for controlling a gain of the out-of-band signal of the out-of-band signal transmission unit in accordance with a level variation of the out-of-band signal received by the out-of-band signal receiving unit.

### TECHNICAL FIELD

The embodiment relates to a digital broadcasting receiving apparatus and method of receiving thereof.

### BACKGROUND ART

As broadcasting media has been digitalized, terrestrial and satellite digital multimedia broadcastings have been serviced. Recently, as the cable broadcasting employs a digital system, the digital multimedia broadcasting is more actively serviced.

As the media utilizing an encoding widely spread, the digitalization of the broadcasting signal will accelerate the communication-computer-broadcasting convergence, enable the internationalization and multi-channel of the single multi-functional media, and provide a variety of data services.

A cable-broadcasting network is designed to broadcast a high quality television signal that is received using a high sensitive antenna to a television of each home. The service of the cable-broadcasting network started to solve a blanket area problem. In addition, the cable-broadcasting network has been developed as media providing a variety of information and local broadcasting programs as it has a broadcasting system itself and a two-way communication function.

FIG. 1 shows a conventional digital cable broadcasting system.

Referring to FIG. 1, a head end 10 transmits a broadcasting signal to a subscriber 30 using a coaxial cable. Here, the head end 10 may be a broadcasting station or an outsourcing program production company. The broadcasting signal is divided into an in-band signal having information within an assigned channel and an out-of-band signal.

The subscriber 30 receives and demodulates a broadcasting signal corresponding to the in-band signal using a set top box 31 and watches the program of the broadcasting signal through a TV 32 or other display set.

The subscriber 30 receives the out-of-band signal to perform the two-way communication. At this point, when the subscriber 30 wishes to take part in a two-way communication program such as a quiz program, the set top box 31 receives an answer of the quiz as an infrared signal from a remote controller 33.

The set top box 31 transmits the received infrared signal together with upstream MAC (media access control) data. If necessary, the received infrared signal may be encoded and digitally modulated through a QPSK or QAM method and transmitted with a desired frequency at the head end 10 through a cable. At this point, unique information of the set top box is transmitted together with the signal.

Then, the head end 10 collects information received through the cable and the information provider can use the collected information data with statistical data.

However, when there is a two-way communication between the head end and the subscriber through the set top box, there may be a transmission loss through a cable network connecting the head end and the set top box of the subscriber. The bead end does not consider the transmission loss of the subscriber in the two-way communication.

Accordingly, there is a difference in a transmission level between a subscriber having the highest cable-network transmission loss and a subscriber having the smallest cable-network transmission loss and thus the cable head end is under recognizing with communication error by a level difference of the received signal.

### DISCLOSURE OF INVENTION

### Technical Problem

An embodiments provides a digital broadcasting receiving apparatus and method of receiving thereof.

An embodiments provides a digital broadcasting receiving apparatus and method of receiving thereof that can automatically adjust a transmission signal level in response to a transmission loss occurring on a cable-network between a cable head end and a subscriber.

An embodiments provides a digital broadcasting receiving apparatus and method of receiving thereof that can improve a communication quality by reducing a communication error between a cable head end and a set top box of a subscriber.

### Technical Solution

An embodiment of the present invention provides a digital broadcasting receiving apparatus including: an out-of-band signal receiving unit for receiving an out-of-band signal through a cable; a out-of-band signal transmission unit for transmitting the out-of-band signal through the cable; and a control unit for controlling a gain of the out-of-band signal of the out-of-band signal transmission unit in accordance with a level variation of the out-of-band signal received by the out-of-band signal receiving unit.

An embodiment of the present invention provides a digital broadcasting receiving method including: receiving an out-of-band signal through a cable; detecting an RF AGC voltage with respect to the received out-of-band signal; converting the detected RF AGC voltage into a digital signal; and adjusting a gain of the out-of-band signal transmitting through the cable in accordance with a variation of the digital signal of the RF AGC voltage.

An embodiment of the present invention provides a digital broadcasting receiving method including: receiving an out-of-band signal and an in-band signal through a cable; detecting an RF AGC voltage with respect to the received out-of-band signal; converting the detected RF AGC voltage into a digital signal; and adjusting a gain of the digital signal transmitting through the cable in accordance with the converted digital signal.

Since a communication error between the cable head end and a set top box of a subscriber is reduced, the communication quality can be improved.

### ADVANTAGEOUS EFFECTS

According to the digital broadcasting receiving apparatus and method of the embodiments, a communication error between the head end and the subscriber is reduced by reading an automatic gain control voltage with respect to a receiving level of an out-of-band signal received through a cable-network, checking the loss on the cable-network of the subscriber, and automatically adjusting a transmission level of the out-of-band signal.

Further, by reducing an error of the data transmitted from the set top box to the head end, the two-way communication quality and the reliability of the set top box can be improved.

### BRIEF DESCRIPTION OF THE DRAWINGS

FIG. 1 is a view of a conventional digital cable broadcasting apparatus;

FIG. 2 is a view of a digital broadcasting receiving apparatus according to an embodiment of the present invention; and

FIG. 3 is a flowchart illustrating a digital broadcasting receiving method according to an embodiment of the present invention.

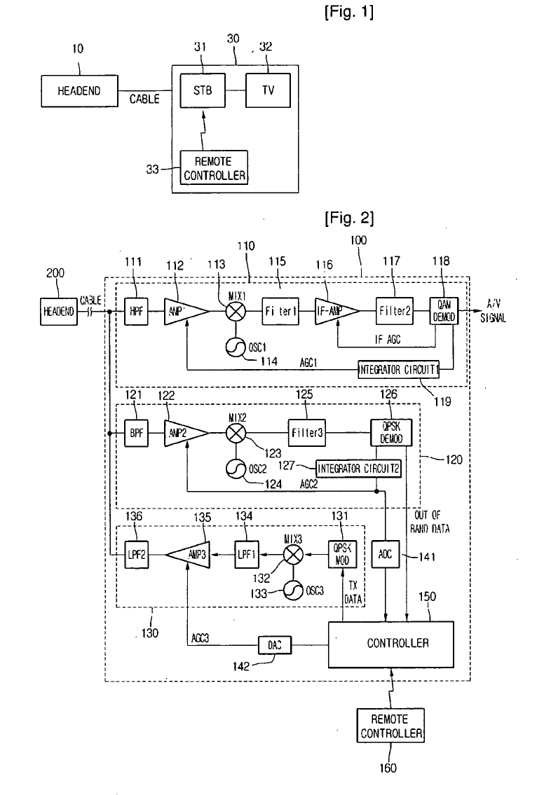

### BEST MODE FOR CARRYING OUT THE INVENTION

The following will describe a digital broadcasting apparatus according to an embodiment of the present invention with reference to the accompanying drawings.

FIG. 2 is a view of a digital broadcasting receiving apparatus according to an embodiment of the present invention.

Referring to FIG. 2, a set top box 100 is connected to a head end 200 through a cable and includes an in-band signal receiving unit 110, an out-of-band signal receiving unit 120, an out-of-band signal transmission unit 130, an analog-digital conversion unit (ADC) 141, a digital-analog conversion (DAC) unit 142, and a control unit 150.

The set top box 100 receives a in-band signal through the cable (e.g., a coaxial cable) connected to the head end 200, demodulates the received signal, and transmits the demodulated signal to a display device such as a TV set. Here, the head end 200 transmits the in-band signal carrying a transport stream (e.g., an MPEG-2 transport stream) such as an image and sound to an open cable set top box. The out-of-band signal is designed to be transmitted or received through a two-way communication between the set top box and the head end.

The in-band signal receiving unit 110 amplifies and filters the in-band signal received from the head end 200 and demodulates the amplified and filtered signal.

To this end, the in-band signal receiving unit 110 includes a high-pass filter 111, a first receiving amplifier (AMP1) 112, a first mixer (MIX1) 113, a first local oscillator 114, a first filter (FILTER1) 115, an intermediate amplifier (IF-AMP) 116, a second filter (FILTER2) 117, a QAM demodulator (QAM DEMOD) 118, and a first integrator circuit 119.

The high-pass filter (HPF) 111 filters a band having a frequency higher than a pre-determined level from high frequency signals inputted through the cable. The first receiving amplifier 112 amplifies a signal level of the high frequency signal filtered by the high-pass filter 111 using a voltage of an automatic gain control (AGC1) that is feedback.

The first mixer (MIX1) 113 mixes the high frequency signal whose signal level is adjusted by the first receiving amplifier 112 with a local oscillation frequency of the first local oscillator 114 to thereby output a desired intermediate frequency. The first filter 115 filters desired frequency signals from the intermediate frequency signals output from the first mixer 113. The intermediate frequency amplifier 116 amplifies the intermediate frequency signals filtered by the first filter 115 using an IF-AGC voltage. The second filter 117 filters the intermediate frequency signals amplified by the intermediate frequency amplifier 116 and the QAM demodulator 118 demodulates the intermediate frequency signals filtered by the second filter 117 into audio/video signals that are broadcasting signals for performing quadrature amplitude modulation (QAM).

Here, the first integrator circuit 119 converts a voltage of RF AGC (AGC1) of the QAM modulator 118 into a direct current (DC) voltage to adjust amplitude of the first receiving amplifier 112 and thus output a uniform intermediate frequency level.

As described above, the AN (audio/video) signals that are filtered, amplified, and demodulated by the in-band signal receiving unit 110 are transmitted to the display device so that the subscriber watches the broadcasting program.

The out-of-band signal receiving unit 120 receives the out-of-band signal from the head end 200 and the out-of-band signal transmission unit 130 transmits the out-of-band signal to the head end 200. The out-of-band signal that is received from head end 200 carries information relating to channels and other information. In more detail, the information may include electronic program guide (EPG) information, impulse-pay-per-view (IPPV) information, data information, emergency alert system (EAS) information, video-on-demand (VOD) information, web information, e-mail information, and the like. Further, the out-of-band signal utilizes a QPSK method for both a down-link and an up-link. The out-of-band signal receiving unit 120 supports a down-link speed of 1.544 Mbps, 2.04 Mbps, 3.088 Mbps, and the like and an up-link speed of 0.256 Mbps, 1.544 Mbps, 3.088 Mbps, and the like. A frequency baseband is 70-130 MHz for the down-link and 5-42 MHz for the up-link. An RF channel bandwidth is 1.0/1.5/2.0 MHz for the down-link and 0.192/1.0/2.0 MHz for the up-link.

The out-of-band signal is operated by an open cable type that can always maintain an enable state regardless of the on/off operation.

The out-of-band signal receiving unit 120 includes a band-pass filter (BPF) 121, a second receiving amplifier (AMP2) 122, a second mixer (MTX2) 123, and a second local oscillator 124, a third filter (FILTER3) 125, a QPSK demodulator (DEMOD) 126, and a second integrator circuit 127.

The band-pass filter (BPF) 121 filters frequency signals that are within a pre-determined bandwidth from the high frequency signals inputted through the cable. The second receiving amplifier 122 amplifies a signal level of the high frequency signal filtered by the band-pass filter (BPF) using a voltage of an automatic gain control (AGC2) that is feed-back. The second mixer (MIX2) 123 mixes the high frequency signal whose signal level is adjusted by the second receiving amplifier 122 with a local oscillation frequency of the second local oscillator 124 to thereby output a desired intermediate frequency. The third filter 125 filters desired frequency signals from the intermediate frequency signals outputted from the second mixer 123. The QPSK de-modulator 126 demodulates the intermediate frequency signals filtered by the third filter 125 into out-of-band data by performing a quadrature phase shift keying (QPSK).

Here, the QPSK demodulator 126 detects a signal level of the intermediate frequency and allows the RF AGC voltage to be output in the form of PWM so that an intermediate frequency having a uniform level can be input. The second integrator circuit 127 converts the RF AGC voltage having the PWM form into the DC voltage to adjust amplitude of the second receiving amplifier 122. The second receiving amplifier 122 outputs an intermediate frequency signal whose amplitude is adjusted by the RF AGC voltage.

At this point, the ADC 141 converts a DC voltage outputted from the second integrator circuit 127 into a digital signal and output the converted digital signal to the control unit 150. The control unit 150 receives a digital signal corresponding to the DC voltage of the RF AGC (AGC2) and checks a network loss in accordance with a DC voltage variation of the RF AGC (AGC2). For example, the control unit 150 is designed to receive a standard digital signal of −5˜15 dBmV for the high frequency signal. The input level of the high frequency signal may be increased or decreased with reference to 5 dBmV. This variation of the input level uniformly compensates for a input level by varying the voltage of the RF AGC (AGC2). At this point, by reading the voltage of the RF AGC (AGC2), it becomes possible to check the network loss of the subscriber.

The out-of-band signal transmission unit 130 includes a QPSK modulator (MOD) 131, a third mixer (MIX3) 132, a third local oscillator 133, a first low-pass filter (LPF1) 134, a transmission amplifier (AMP3) 135, and a second low-pass filter (LPF2) 136. The QPSK modulator 131 modulates subscriber data (Tx DATA) inputted through, for example, a remote controller 160, using a QPSK method. The third mixer 132 mixes the modulated signal with a local oscillation frequency of the third local oscillator 134 and outputs a high frequency signal. The first low-pass filter 134 filters only a low frequency band from the high frequency signals outputted from the third mixer 132. The transmission amplifier 135 amplifies the signal filtered by the first low-pass filter 134 using an automatic gain control signal (AGC3) outputted from the control unit 150. The second low-pass filter 136 filters only a low frequency band from the signals amplified by the transmission amplifier 135 and transmits the filtered low frequency signals to the head end 200.

The control unit 150 checks a network loss in accordance with a voltage of the RF AGC (AGC2) of the out-of-band signal received from the out-of-band signal receiving unit 120 and outputs a transmission side gain control signal to compensate for a level corresponding to the network loss. The transmission side gain control signal is converted into an analog signal by the DAC unit 142 and then adjusts amplitude of the transmission amplifier 135.

As described above, when the subscriber data are inputted through the remote controller 160, the control unit 150 automatically adjust the gain of the transmission signal in accordance with the network loss with respect to the receiving level of the out-of-band signal and the transmission signal whose gain is adjusted is transmitted to the head end 200 through the cable, thereby reducing the transmission error of the subscriber data.

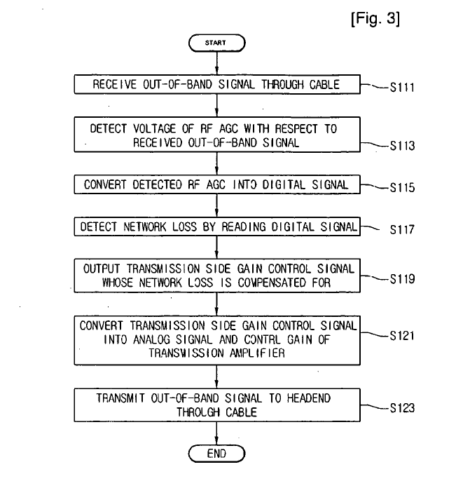

Meanwhile, FIG. 3 is a flowchart illustrating a digital broadcasting receiving method according to an embodiment of the present invention.

Referring to FIG. 3, the out-of-band signal receiving unit is received from the out-of-band signal through the cable connected to the head end (S111). At this point, a voltage of the RF AGC for the out-of-band signal received is detected, converted into a digital signal, and transmitted to the control unit (S113, S115). The control unit checks variation information of the voltage of RF AGC from the digital signal inputted and thus detects the network loss of the subscriber (S117).

Subsequently, the transmission side gain control signal whose network loss is compensated for is output and converted into an analog signal by the DAS unit (S119) and adjusts the gain of the transmission amplifier of the out-of-band signal transmission unit (S121). The out-of-band signal whose gain is adjusted by the out-of-band signal transmission unit is transmitted to the head end through the cable (S123).

It will be apparent to those skilled in the art that various modifications and variations can be made in the present invention. Thus, it is intended that the present invention covers the modifications and variations of this invention provided they come within the scope of the appended claims and their equivalents.

### INDUSTRIAL APPLICABILITY

In the digital broadcasting receiving apparatus and method according to the present invention, a communication error between the head end and the subscriber can be reduced by reading an automatic gain control voltage with respect to a receiving level of an out-of-band signal received through a cable-network, checking the loss on the subscriber cable-network, and automatically adjusting a transmission level of the out-of-band signal.

Further, by reducing an error of the data transmitted from the set top box to the head end, the two-way communication quality and the reliability of the set top box can be improved.

1. A digital broadcasting receiving apparatus comprising:
an out-of-band signal receiving unit for receiving an out-of-band signal through a cable;
an out-of-band signal transmission unit for transmitting the out-of-band signal through the cable; and
a control unit for controlling a gain of the out-of-band signal of the out-of-band signal transmission unit in accordance with a level variation of the out-of-band signal received by the out-of-band signal receiving unit.

2. The digital broadcasting receiving apparatus according to claim 1, wherein the control unit checks a network loss of a subscriber by an RF AGC voltage of the out-of-band signal receiving unit and automatically adjusts a transmission level of the out-of-band signal.

3. The digital broadcasting receiving apparatus according to claim 2, further comprising an analog-digital converter for converting the RF AGC voltage of the out-of-band signal received from the out-of-band signal receiving unit into a digital signal and outputting the converted digital signal to the control unit.

4. The digital broadcasting receiving apparatus according to claim 1, further comprising a digital-analog converter that converts a gain control signal output to the out-of-band signal transmission unit into an analog signal to adjust an amplifier gain of the out-of-band signal transmission unit.

5. The digital broadcasting receiving apparatus according to claim 1, further comprising an in-band signal receiving unit for receiving an in-band signal through the cable and demodulating the received in-band signal.

6. The digital broadcasting receiving apparatus according to claim 1, wherein the out-of-band signal receiving unit includes:
a band-pass filter for filtering a high frequency signal received through the cable;
an amplifier for amplifying the filtered high frequency signal using an automatic gain control voltage;
a mixer for tuning the signal amplified by the amplifier into an intermediate frequency;
a receiving filter for filtering the tuned intermediate frequency;
a demodulator for demodulating the signal filtered by the receiving filter; and
an integrator circuit for receiving an automatic gain control signal from the demodulator and outputting the automatic gain control signal as an RF AGC voltage.

7. The digital broadcasting receiving apparatus according to claim 1, wherein the out-of-band signal transmission unit includes a modulator for receiving subscriber data from the control unit and modulating the received subscriber data; a mixer for mixing the modulated signal with a local oscillation frequency; a receiving filter for a first low-pass filter for filtering a low-pass band from the signal outputted from the mixer; a transmission amplifier for amplifying a signal outputted from the first low-pass filter using a transmission side gain control signal; and a second low-pass filter for filtering a low-pass band from the amplified signal.

8. A digital broadcasting receiving method comprising:
receiving an out-of-band signal through a cable;
detecting an RF AGC voltage with respect to the received out-of-band signal;
converting the detected RF AGC voltage into a digital signal; and
adjusting a gain of the out-of-band signal transmitting through the cable in accordance with a variation of the digital signal of the RF AGC voltage.

9. The digital broadcasting receiving method according to claim 8, wherein the adjusting of the gain includes allowing the control unit to read the converted digital signal; detecting a network loss according to the digital signal read by the control unit; outputting the transmission side gain control signal whose network loss is compensated for; and automatically adjusting the gain of the transmission amplifier by converting the transmission side gain control signal into an analog signal.

10. The digital broadcasting receiving method according to claim 9, wherein the network loss is a loss occurring on a cable network between the subscriber and a head end.

11. A digital broadcasting receiving method comprising:
receiving an out-of-band signal and an in-band signal through a cable;
detecting an RF AGC voltage with respect to the received out-of-band signal;
converting the detected RF AGC voltage into a digital signal; and
adjusting a gain of the digital signal transmitting through the cable in accordance with the converted digital signal.

12. The digital broadcasting receiving method according to claim 11, wherein the adjusting of the gain includes detecting a cable-network loss between a subscriber and a head end using a digital signal of the RF AGC voltage; and adjusting an amplitude of the transmission amplifier using the gain control signal whose lost information on a subscriber network are compensated.
